(19) United States
(12) Patent Application Publication
(10) Pub. No.: US 2004/0096007 A1
(43) Pub. Date: May 20, 2004

(54) Method for generating soft bit information from gray coded signals

(76) Inventors: Volker Aue, Dresden (DE); Rene Nuessgen, Dresden (DE)

Correspondence Address: BAKER & BOTTS, 30 ROCKEFELLER PLAZA, NEW YORK, NY, 10112

(21) Appl. No.: 10/399,184

(22) PCT Filed: Oct. 15, 2001
(86) PCT No.: PCT/DE01/03917

(30) Foreign Application Priority Data
Oct. 16, 2000 (DE) 10051283.6

(51) Int. Cl. H04L 5/12; H04L 23/02

(52) U.S. Cl. 375/261

(57) ABSTRACT

The present invention provides a method for generating soft bit information from Gray coded signals. By using Gray coding, soft bit information is generated for each bit by performing simple absolute value generation and substraction. Prior to the actual soft bit calculation, a complex received symbol Y (Y=S.H+N) is multiplied by a complex conjugate H* of a channel transfer function H to provide a received symbol (R=S./H/²+NH*) corrected for phase and weighted for the channel amplitude. Thereafter, the soft bit information (D(R,S)₁) for the in-phase and quadrature components of an m-valued QAM signal is calculated.

The invention relates to a method for generating soft bit information from Gray coded signals.

Trellis coded modulation (TCM) has been used in the past for band-limited channels. TCM combines coding and modulation, where the coded bits are assigned to corresponding points in a constellation diagram. In this way, the minimum Euclidean distance is maximized. Because of growing interest in mobile radio channels (e.g. Rayleigh fading), suitable further development has been carried out on existing methods. The goal was to develop new coding methods for frequency selective channels while still being able to use existing standard algorithms such as a Viterbi decoder. To this end, the approach of combining coding and modulation was abandoned. This was achieved by means of an additional bitwise interleaving at the encoder output and an appropriate soft metric calculation in the receiver. This method is called bit interleaved coded modulation (BICM). So-called Gray coding plays a critical role in this method. Adjacent symbols in the constellation diagram differ by only one different bit. When soft bit information is generated from Gray coded signals, the soft information for each bit results from the maximum conditional probability that a data symbol was received under the condition that a specific data symbol was sent.

A disadvantage of the methods for soft bit calculation previously used is the high computational effort in the actual calculation and sometimes an additional high hardware cost, for example in order to compare the conditional probability information. The high computational effort consists on the one hand of the calculation of multiple conditional probabilities and on the other hand of an additional division by the channel transfer function. This additional division must be employed when BICM (bit interleaved coded modulation) and fading are assumed. In practice, the individual bits are additionally interleaved across different symbols.

The object of the invention is to calculate the soft bit information with at least equivalent performance regarding bit and symbol error rates with reduced computational and hardware expense in order to be able to achieve a suitable implementation in real-time systems with stringent time requirements.

The object is achieved in accordance with the invention in a method for generating soft bit information from Gray coded signals in that the Gray coding used in most cases is utilized and generation of the soft bit information for each bit is performed through simple absolute value generation and subtraction.

Prior to the actual soft bit calculation, the complex received symbols Y are multiplied by the complex conjugate of the estimated channel transfer function H (for transfer in the frequency domain) in order to eliminate any possible phase rotation caused by the channel. For transfer in the time domain, H* contains the channel coefficient that results from signal fading and phase rotation.

Y is the received symbol.

Y=S·H+N

S is the transmitted signal, H is the transfer function, and N is the corresponding noise term.

After complex multiplication and the assumption of ideal channel estimation, the received symbol, corrected for phase and weighted for the channel amplitude, is obtained

R=S·|H|²+NH*.

A QAM signal can be treated as two ASK signals due to the orthogonality of the in-phase and quadrature components. The soft bit information D(R,S)ᵢ for the in-phase and quadrature components of an m-valued QAM symbol is calculated from

D(R,S)ᵢ=Re{R} for the in-phase components and

D(R,S)ᵢ32 Im{R} for the quadrature components and

D(R,S)ᵢ=−abs(D(R,S)ᵢ₋₁)+sᵢ for i≧2.

Re{R} represents the real part of a complex number, Im{R} represents the imaginary part.

The shift factor sᵢ results from the threshold value for a hard decision for the corresponding bit and the channel transfer function H, and is calculated as follows:

sᵢ=v_{Ti}|H|²

The threshold value v_{Ti} is calculated as follows:

v_{Ti}=2^{ld(m)/2-(i-1)}

where m is the number of constellation points in the complex signal plane, and “ld” represents the logarithm to the base of 2.

With this new method, it is not necessary to perform a complicated division by the channel transfer function under the above-described boundary conditions such as BICM and frequency-selective fading. The decision limits, like the shift factors, can be calculated recursively. The following applies:

v_{Ti+1}=v_{Ti}/2

sᵢ₊₁=sᵢ/2

Thus, once the shift factor for the first bit is known, all additional soft bits can be calculated in a simple manner. The new method saves computational expenditure and if applicable, hardware costs.

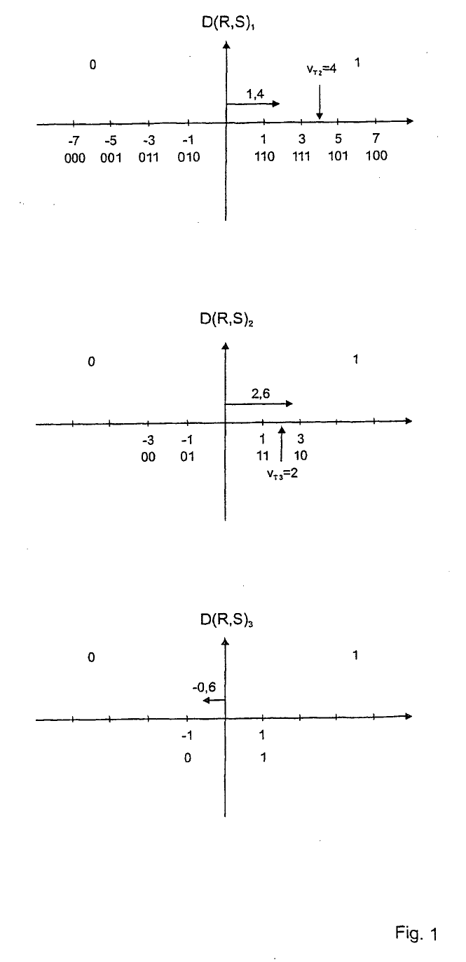

The invention is explained in detail below on the basis of two example embodiments. FIG. 1 shows a Gray coding wherein the following Gray code was used for the in-phase component of a 64-QAM symbol. The individual calculation steps for bit 2 and bit 3 are illustrated here.

The Gray code is documented in the table below.

| Bit | Bit | Bit | |
|---|---|---|---|
| 1 | 2 | 3 | Y |
| 0 | 0 | 0 | −7 |
| 0 | 0 | 1 | −5 |
| 0 | 1 | 1 | −3 |
| 0 | 1 | 0 | −1 |
| 1 | 1 | 0 | 1 |
| 1 | 1 | 1 | 3 |
| 1 | 0 | 1 | 5 |
| 1 | 0 | 0 | 7 |

This example assumes that H=1, v_{T1}=8. The real part of the symbol received with the complex conjugate transfer factor H* is 1.4.

Accordingly, the first soft bit D(R,S)₁=1.4. The second soft bit, with v_{T2}=4, s₂=4, is obtained from the formula as D(R,S)₂=−abs(1.4)+4=2.6.

The third soft bit, with v_{T3}=2, s₃=2, is obtained from the formula as D(R,S)₃=−abs(2.6)+2=−0.6.

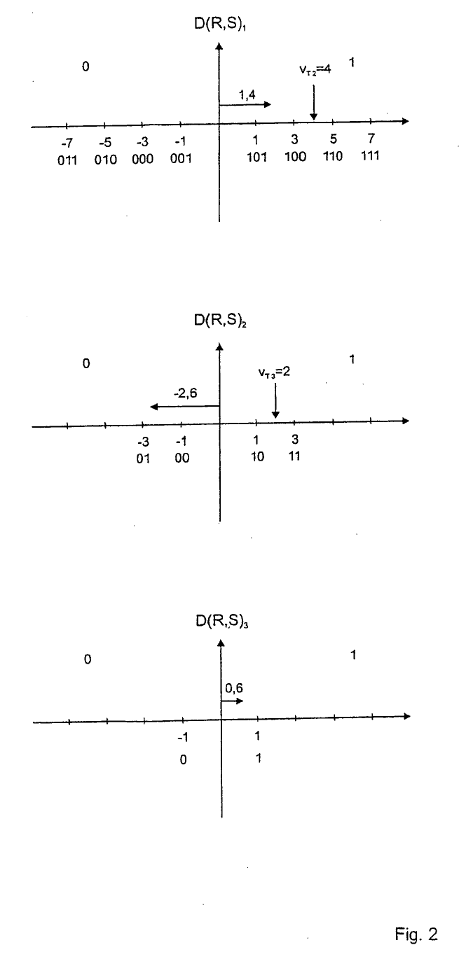

FIG. 2 shows another Gray coding wherein a different Gray code was used for the in-phase component of a 64-QAM symbol. The Gray code is documented in the table below.

| Bit | Bit | Bit | |
|---|---|---|---|
| 1 | 2 | 3 | Y |
| 0 | 1 | 1 | −7 |
| 0 | 1 | 0 | −5 |
| 0 | 0 | 0 | −3 |
| 0 | 0 | 1 | −1 |
| 1 | 0 | 1 | 1 |
| 1 | 0 | 0 | 3 |
| 1 | 1 | 0 | 5 |
| 1 | 1 | 1 | 7 |

This example assumes that H=1, v_{T1}=8. The real part of the symbol received with the complex conjugate transfer factor H* is 1.4.

Accordingly, the first soft bit D(R,S)₁=1.4. The second soft bit, with v_{T2}=4, s₂=4, is obtained from the formula as D(R,S)₂=abs(1.4)−4=−2.6. The third soft bit, with v_{T3}=2, s₃=2, is obtained from the formula as D(R,S)₃=abs(−2.6)−2=0.6.

### List of Formula Symbols

Y received symbol

H channel transfer function

H* complex conjugate of the channel transfer function

S transmitted signal

N noise term

R received symbol, corrected for phase and weighted for the channel amplitude

D(R₂S)ᵢ soft bit information

sᵢ shift factor

V_{Ti} threshold value

m number of constellation points in the complex signal plane

i bit index

1. Method for generating soft bit information from Gray coded signals, characterized in that, using Gray coding, generation of the soft bit information for each bit is performed through simple absolute value generation and subtraction, wherein prior to the actual soft bit calculation, the complex received symbols Y as Y=S·H+N are multiplied by the complex conjugate H of the channel transfer function H thus eliminating any phase rotation caused by the channel, in that after complex multiplication and the assumption of ideal channel estimation, the received symbol, corrected for phase and weighted for the channel amplitude, is obtained
R=S·|H|²+NH*,
and in that the soft bit information D(R,S)ᵢ for the in-phase and quadrature components of an m-valued QAM symbol is calculated from
D(R,S)ᵢ=Re{R} for the in-phase components and
D(R,S)ᵢ=Im{R} for the quadrature components and
D(R,S)ᵢ=−abs(D(R,S)ᵢ₋₁)+sᵢ for i≧2
wherein sᵢ represents shift factors as
sᵢ=v_{Ti}|H|² and
v_{Ti} represents threshold values as
v_{Ti}=2^{ld(m)/2-(i-1)}.

2. Method in accordance with claim 1, characterized in that ASK signals are used instead of a QAM signal.
v_{Ti}=2^{ld(m)-i-1}

3. Method in accordance with claim 1 and 2, characterized in that a transfer function Ĥ estimated from the received signal is used, and that
R=SH\tilde{H}+N\tilde{H} results.

4. Method in accordance with claims 1-3, characterized in that a different Gray coding is used and
D(R,S)=abs(D(R,S)ᵢ₋₁)−sᵢ is calculated for i≧2.

5. Method in accordance with claims 1-4, characterized in that, for different Gray code constellations, depending on the bit index i, either
D(R,S)=abs(D(R,S)ᵢ₋₁)−sᵢ for i≧2
or
D(R,S)=−abs(D(R,S)ᵢ₋₁)+sᵢ for i≧2.
is calculated.

6. Method in accordance with claims 1-5, characterized in that R and sᵢ are scaled with a real constant and in that this scaling is performed with a number less than one in particular for the values for which |H|₂ is greater than an upper limit defined by the receiver.

7. Method in accordance with claims 1-6, characterized in that R is scaled with a real number and in that all sᵢ are scaled with another real number.
